(19) United States
(12) Patent Application Publication
(10) Pub. No.: US 2013/0093566 A1
(43) Pub. Date: Apr. 18, 2013

(54) Kidz trak

(71) Applicant: Lelan William Zales, Los Angeles, CA (US)

(72) Inventor: Lelan William Zales, Los Angeles, CA (US)

(21) Appl. No.: 13/317,352

(22) Filed: Oct. 17, 2011

(51) Int. Cl. G08B 21/02

(52) U.S. Cl. 340/8.1

(57) ABSTRACT

The present invention is designed solely for the prevention of harm and to secure the safety and well being of children. It is not designed as a toy or a watch; it is to be considered a valuable weapon in the fight against child abuse.

### BACKGROUND OF THE INVENTION

This invention relates to a Parent-Child safety bracelet. A set safety zone is created when bracelets are in close proximity.

### SUMMARY OF THE INVENTION

The present invention is basically adult unit #1 and child unit #2

Both units operate on a precise 433 MHZ radio frequency. The adult unit #1 is at all times acting as a receiving unit from a radio frequency sent from child unit #2.

Adult unit #1 only operates as a sending unit to signal Child unit #2 when a locate button is depressed to activate an audible signal on unit #2.

### BRIEF DESCRIPTION OF DRAWINGS

Pages 6-14 show brief descriptions.

FIG. 1

Is a front top perspective view of the kidz proximity device.

FIG. 2

Is a front bottom perspective view of said proximity device.

FIG. 3

Is a front view thereof.

FIG. 4

Is a back view thereof.

FIG. 5

Is a right side view thereof.

FIG. 6

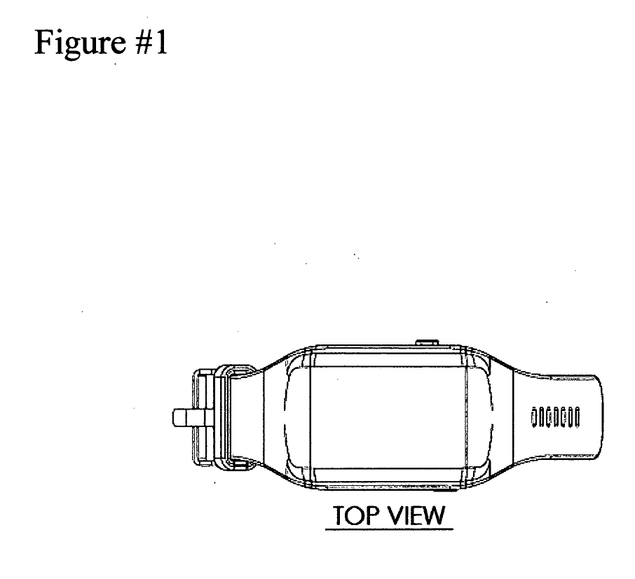

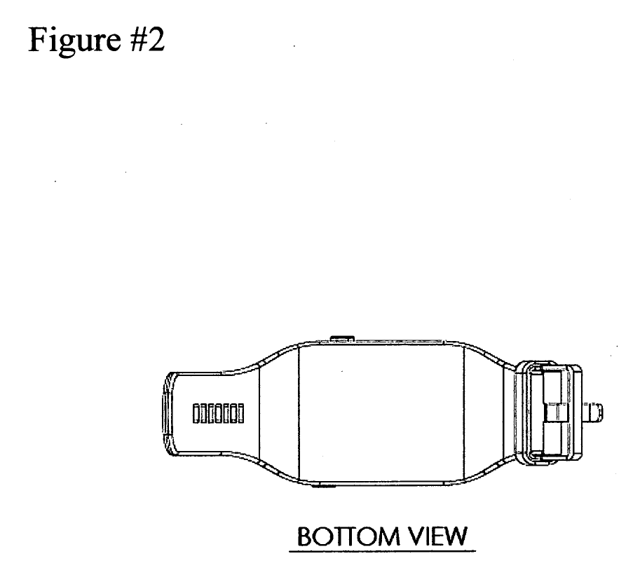

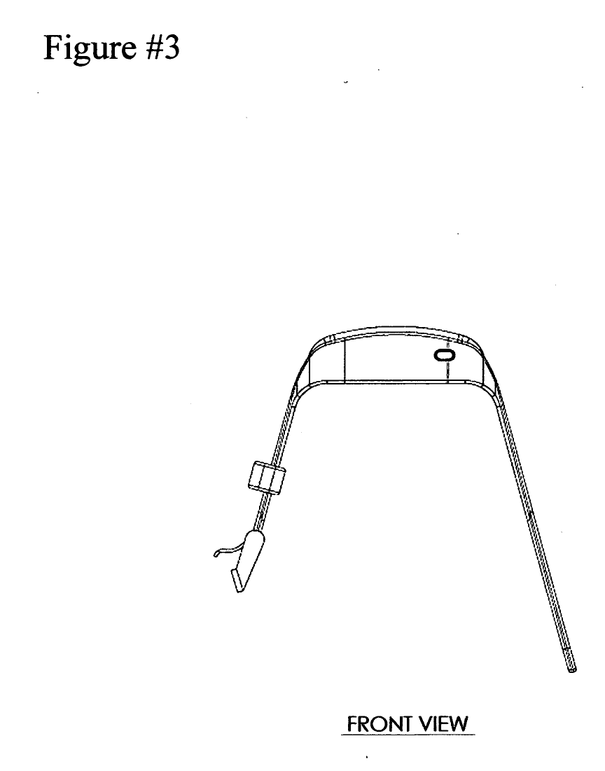

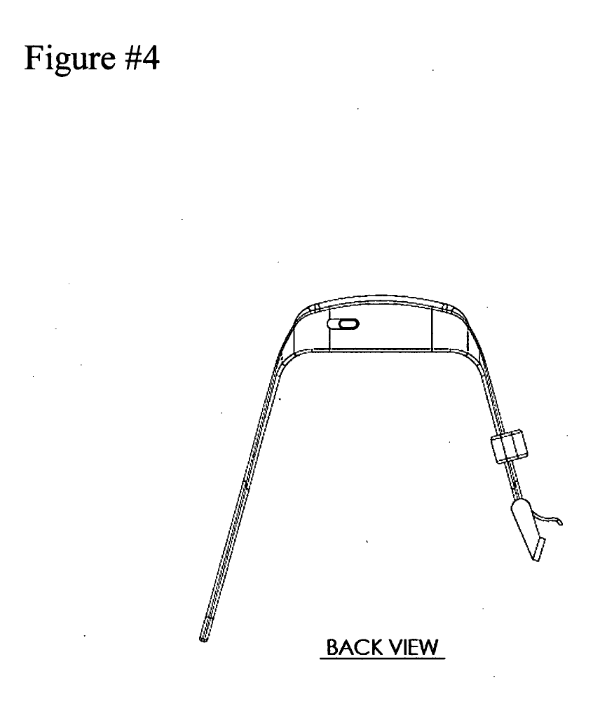

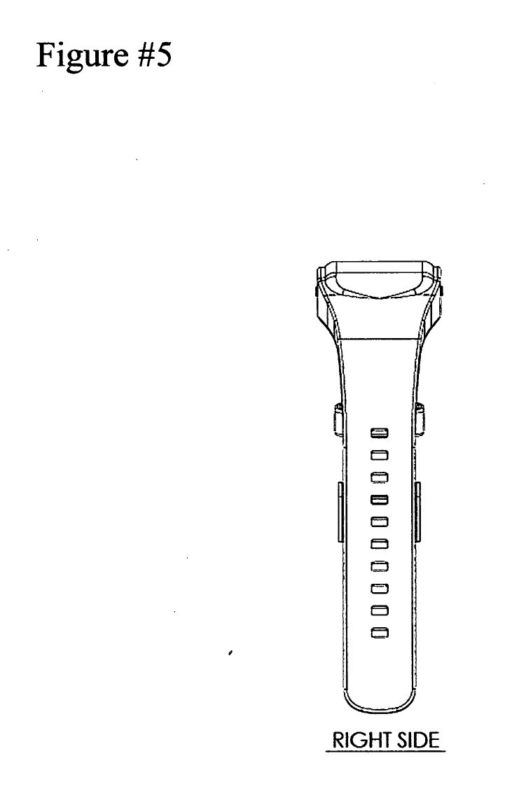

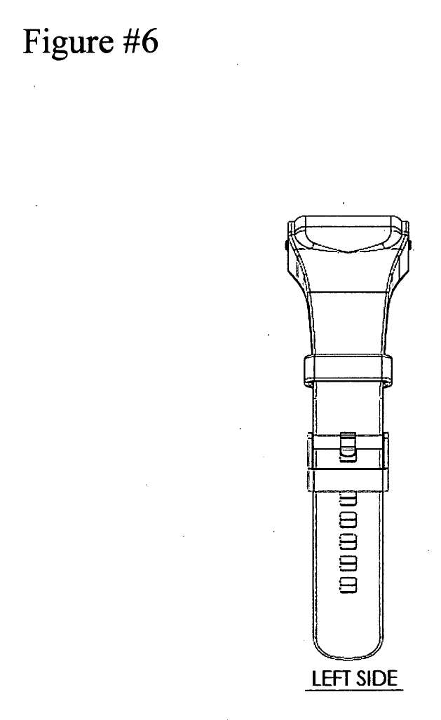

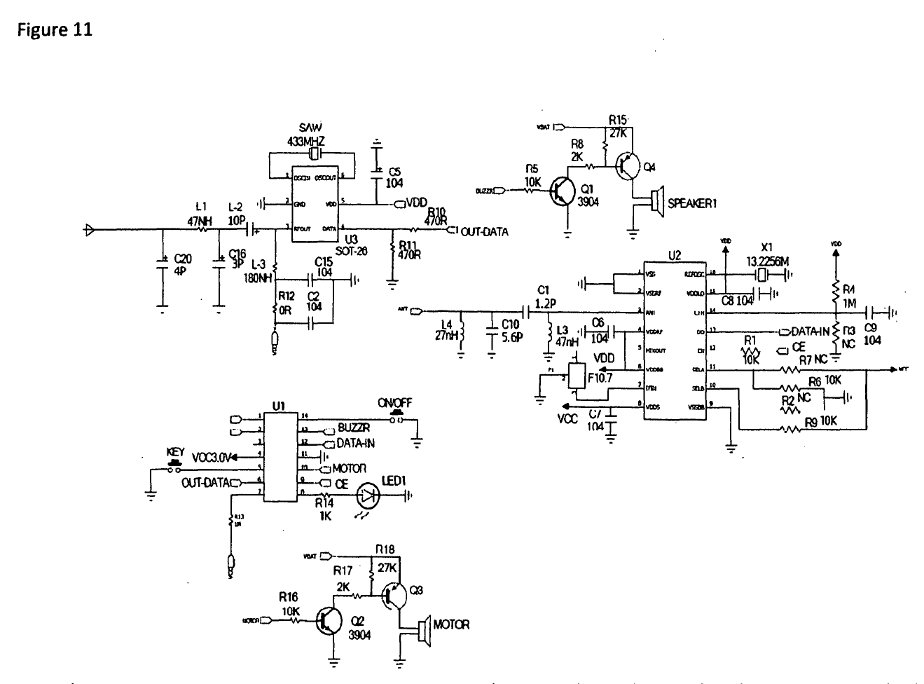

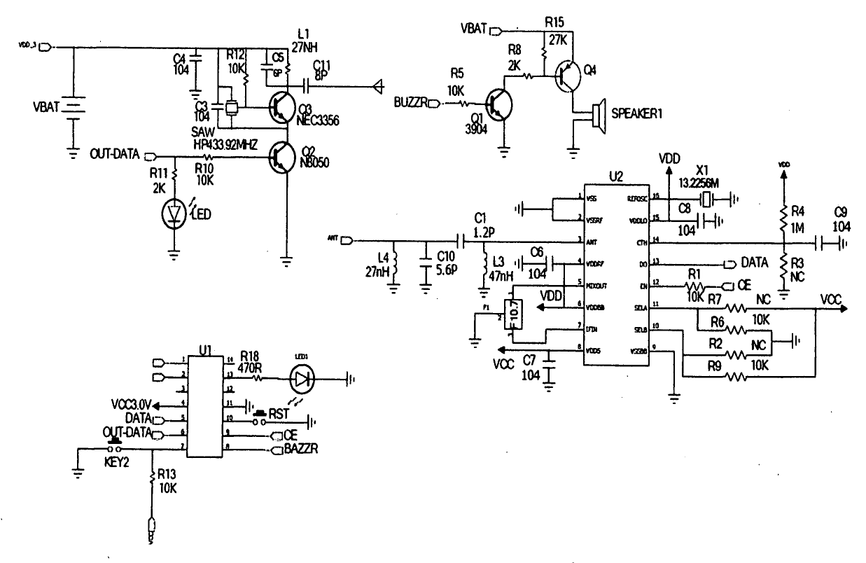

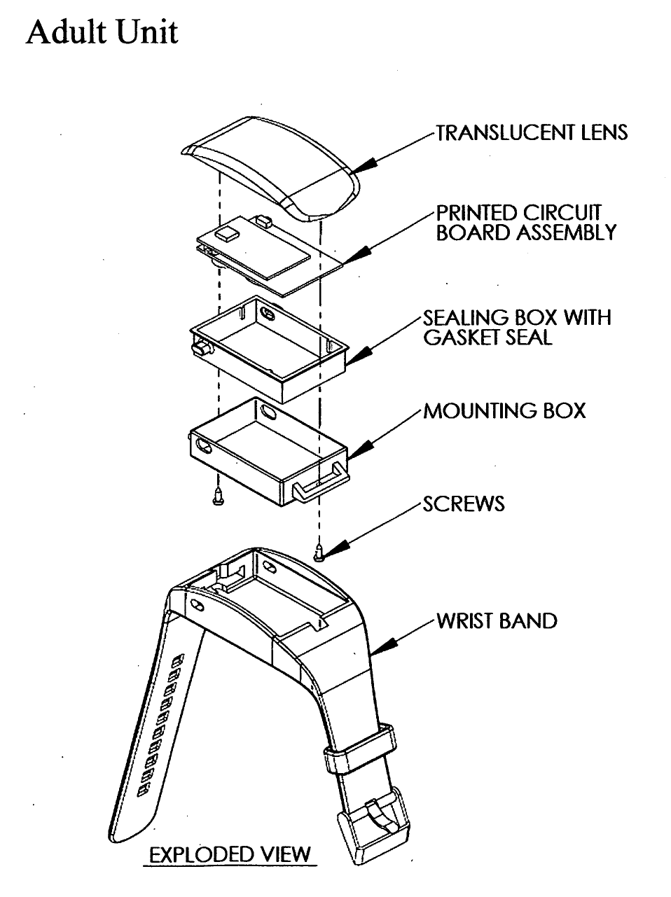

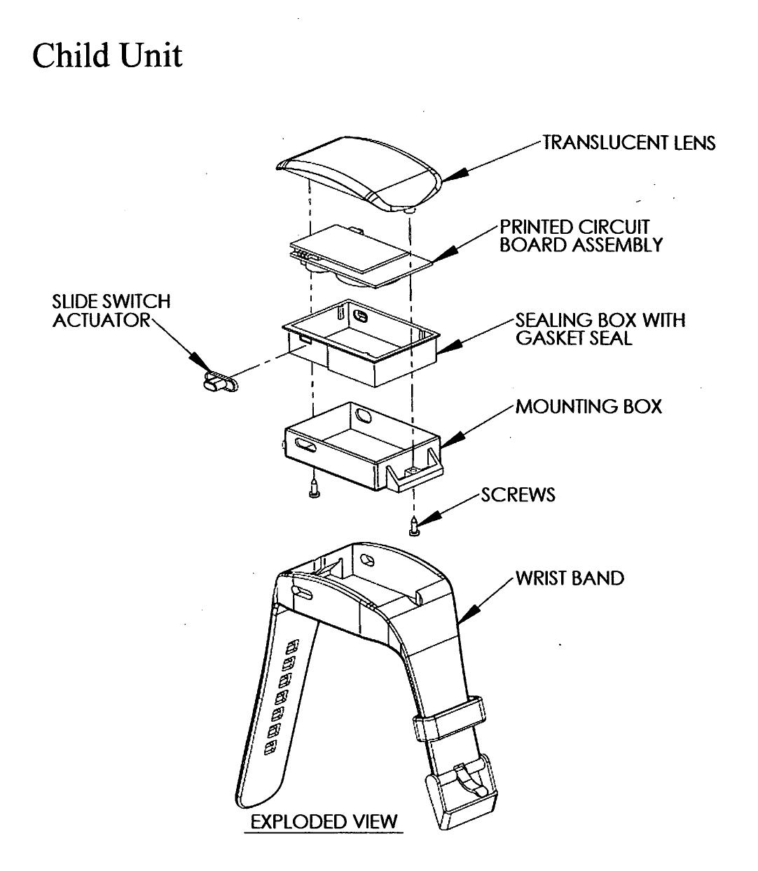

Is a left side view thereof.

### DETAILED VIEW OF INVENTION

Page #21 is a description of the micro-chip board showing the functioning PC board.

Page #22 is a description of the adults micro chip board showing its functions.

Page #15 demonstrates the exploded views of the adult unit and page #16 demonstrates the exploded views of the child proximity device.

A proximity locator that only functions using two components, i.e. Adult units, child units.

1. At all times, the adult unit is acting as a receiving unit from a 433 MHz Radio frequency set from corresponding unit #2 (child unit)

2. Adult unit #1 will only act as a sending unit when a locate button is depressed.

3. Both units have three functions, when devices are in close proximity nothing happens. However, when both units are far enough apart the radio frequency directs the adult device to activate the functions. It flashes through a transparent lens on the top of the device it flashes through an LED light under the same transparent lens cover and it vibrates from a motion sensor embedded in the center of the top of the unit.
